(19) United States
(12) Patent Application Publication
(10) Pub. No.: US 2014/0353370 A1
(43) Pub. Date: Dec. 4, 2014

(54) RF Tag Detection

(71) Applicant: OXEMS (Ireland) Limited, Howth (IE)

(72) Inventors: Michael Hendry, Ipswich (GB); Kevin Gooding, Ipswich (GB); David Edwards, Oxon (GB)

(21) Appl. No.: 14/348,037

(22) PCT Filed: Sep. 7, 2012
(86) PCT No.: PCT/EP2012/067533

§ 371 Date: Mar. 27, 2014

(30) Foreign Application Priority Data
Sep. 7, 2011 (GB) 1115469.7

(51) Int. Cl. G01V 3/12; G01V 15/00

(52) U.S. Cl. CPC G01V 3/12; G01V 15/00
USPC 235/375; 235/439; 235/492

(57) ABSTRACT

A detector comprises a radio-frequency, RF, transmit antenna; a RF receive antenna; and a cable avoidance tool, CAT, antenna.

The present invention relates to an RF detector, an RF tag, and a method of making an RF tag. The invention also relates to an underground utility detection system, and a method of determining a location of an RF detector. The present invention is particularly suitable for use in detecting or locating buried assets, such as utility pipes or cables.

### BACKGROUND

Determining the location and identity of a buried asset can be a challenging task. Traditionally, determination of the location may be performed by systematically digging holes until the asset is found. More recently, ground penetrating radar (GPR) has been used in order to locate a buried asset based on a signal reflected by the asset. (Reference to GPR includes radiation having a frequency in the range of from around 200 MHz to around 1 GHz. Other frequencies are also useful).

However, assets made of certain materials may not provide a strong enough reflected signal to allow the location of the asset to be clearly identified. Furthermore, radiation can be reflected by a number of features of a volume of ground, including variations in moisture content, solids composition, the presence of wildlife, and voids formed for example by tunnelling wildlife. Thus it can be difficult to reliably identify a location of a buried asset using GPR.

In WO 2009/101450, WO 2009/101451 and WO 2011/073657, which are incorporated herein in their entirety by reference, a technique has been described that allows such assets to be tagged using a resonant radar reflector assembly. The described resonant radar reflector assembly includes one or more resonant radar reflector members arranged to reflect radiation in the GPR frequency range, so as to provide a clear reflected signal that can be used to identify the location of the buried asset. Furthermore, by combining resonant reflector members having different associated resonant frequencies, each asset may be identified by the combination of frequencies reflected.

Thus, using the tagging technique described in WO 2009/101450 the presence of a specific buried asset can be detected, and its location more easily determined. However, this tagging technique is not suitable for metal, and particularly ferrous, assets, since the asset prevents the reflection of the RF signal by the tag.

Common types of buried asset which may need to be located include fluid carrying pipes such as water pipes. A common scenario in which it is necessary to locate such an asset is in the event of the asset requiring maintenance such as to fix a leak.

A Cable Avoidance Tool (CAT) may be used to detect metallic pipes and cables, but cannot be used to locate non-metallic assets, such as plastic piping. Accordingly, an alternative technology must be used to detect non-metallic assets. Because of this, it is necessary to provide different systems for detecting metallic and non-metallic assets, leading to a need for additional equipment and increased cost.

When attempting to detect buried assets using an RF tagging system, it is desirable to minimize the area within which a search must be conducted, particularly when multiple tags or a specific tag is to be found. Global Positioning System, GPS, is a known system for determining a location. When the GPS coordinates (or other coordinates that can be compared with GPS coordinates) of a tag are known, it is possible to limit the search area. However, civilian GPS is limited to an accuracy of approximately 10 m to 15 m. Accordingly, civilian GPS reduces the search region to an area approximately 15 m in diameter. It is desirable to further reduce the search area. Differential GPS is a known method of improving GPS accuracy, but is prohibitively expensive to implement for most utility applications. Furthermore, it is needed when initially cataloguing the tag location, and additionally each time the tag is searched for. This increases the cost further.

### BRIEF SUMMARY OF THE DISCLOSURE

Aspects and embodiments of the invention seek to address one or more of the shortcomings of the prior art.

Aspects and embodiments of the invention are set out in the appended claims.

### BRIEF DESCRIPTION OF THE DRAWINGS

Embodiments of the invention are further described hereinafter with reference to the accompanying drawings, in which:

FIG. 1 is a schematic illustration of a detector portion according to an embodiment of the invention.

FIG. 2 illustrates a known transmit and receive coil arrangement.

FIG. 3 illustrates a detector according to an embodiment of the invention.

FIG. 4 illustrates the detector portion of FIG. 1 viewed along direction A.

FIG. 5 illustrates a tag according to another embodiment.

FIG. 6 illustrates a method according to a further embodiment.

### DETAILED DESCRIPTION

Aspects and embodiments of the invention relate to RF tags and detectors for RF tags. Herein the term RF tag is used to describe a device having a resonant circuit that is arranged to be excited by an RF signal, at the resonant frequency, transmitted by a remote device, and in response to the RF signal, to resonate and reflect a signal at the resonant frequency. In preferred embodiments, the RF signal is a GPR signal. In some embodiments the tags resonate at a plurality of frequencies.

Embodiments of the present invention are particularly advantageous for use in detecting buried assets, such as underground utility pipes and cables. However, other applications are also foreseen.

### Detector

According to an aspect of the invention, a device is provided that includes an RF tag detector and a CAT. Combining an RF tag detector and CAT in a single device leads to reduced cost and requires less equipment to be transported to a site. However, it is well known in the art that any ferrous material close to the RF antennas would lead to excessive interference with the operation of the RF antennas, rendering them unable to operate satisfactorily. As the CAT requires one or more coils with ferrous cores, a prejudice existed in the art preventing the skilled person from contemplating a device that included both an RF tag detector and a CAT. Investigation performed by the present inventors has shown that a CAT coil may be provided in a device alongside an RF tag detector with no, or negligible, negative effect on the performance of the RF tag detector.

FIG. 1 shows an embodiment of a detector portion. The detector portion 100 includes an RF transmit antenna 110, arranged to excite an RF resonator in a buried RF tag, a receive antenna 120, arranged to detect a resonant signal reflected by the RF tag. The transmit 110 and receive 120 antennas may be coils, and may be substantially flat and substantially square. Other shapes may also be used. The detector portion further includes a CAT coil 130, which is typically a coil wound on a ferrite rod core. When in use the transmit coil is located close, and approximately parallel to, the detection surface 105. Here detection surface 105 refers to a surface within which the asset to be detected is believed to be; in the case of buried assets, this would be the ground.

According to the arrangement of FIG. 1, both the transmit antenna 110 and the CAT coil 130 are located close to the detection surface 105 (when the detector is in use) which improves performance. It is preferable for both transmit antenna 110 and CAT coil 130 to be close to a common side of the housing 140, that can be placed close to a detection surface 105.

The CAT coil 130 is preferably located outside of the transmit antenna 110, such that the CAT coil 130 does not overlap the transmit antenna 110 when viewed perpendicular to the plane of the transmit antenna. Where the transmit antenna 110 defines a loop, the CAT coil 130 is preferably outside the loop. This is believed to reduce the interference of the CAT coil 130 on the transmit antenna 110.

The axis of the CAT coil 130 (along the direction of the ferrite rod core) is substantially parallel to the plane of the transmit antenna 110. When the axis of the CAT coil 130 is perpendicular to the plane of the transmit antenna 110, interference by the CAT coil 130 on the operation of the RF detector is increased.

The axis of the CAT coil 130 may be substantially in the plane of the transmit antenna 110. Preferably the plane of the transmit antenna 110 is arranged, in use, to be close to a detection surface. When the CAT coil 130 is in the plane of the transmit coil 110, this results in the CAT coil 130 being close to the detection surface, which improves the effectiveness of the CAT coil 130. Where the transmit antenna 110 has one or more substantially straight sides, for example when the transmit antenna is substantially square, the axis of the CAT coil 130 may be parallel to a side of the transmit antenna 110.

The plane of the CAT coil 130 may be considered to be perpendicular to the axis of the CAT coil 130. According to preferred embodiments, the plane of the CAT coil 130 is perpendicular to the plane of the transmit antenna 110.

According to the present embodiment, the transmit 110 and receive 120 antennas are displaced vertically (when oriented for use) such that the antennas 110, 120 are substantially in parallel planes, the planes being displaced from each other in a direction perpendicular to the planes. The antennas 110, 120 are also displaced horizontally; preferably such that they substantially do not overlap when viewed perpendicular to the planes. As can be seen, the receive antenna 120 is not inside the transmit antenna 110 or between portions of the transmit antenna 110. According to the present embodiment, the transmit antenna 110 is below the receive antenna 120, closer to the detection surface when in use. Improved performance is obtained when the transmit antenna 110 is closer to the detection surface 105 than the receive antenna 120, compared with an arrangement in which the receive antenna 120 is closer to the detection surface 105 than the transmit antenna 110. The transmit 110 and receive 120 antennas of FIG. 1 are arranged such that the receive antenna 120 is located at a null point of the transmit antenna 110.

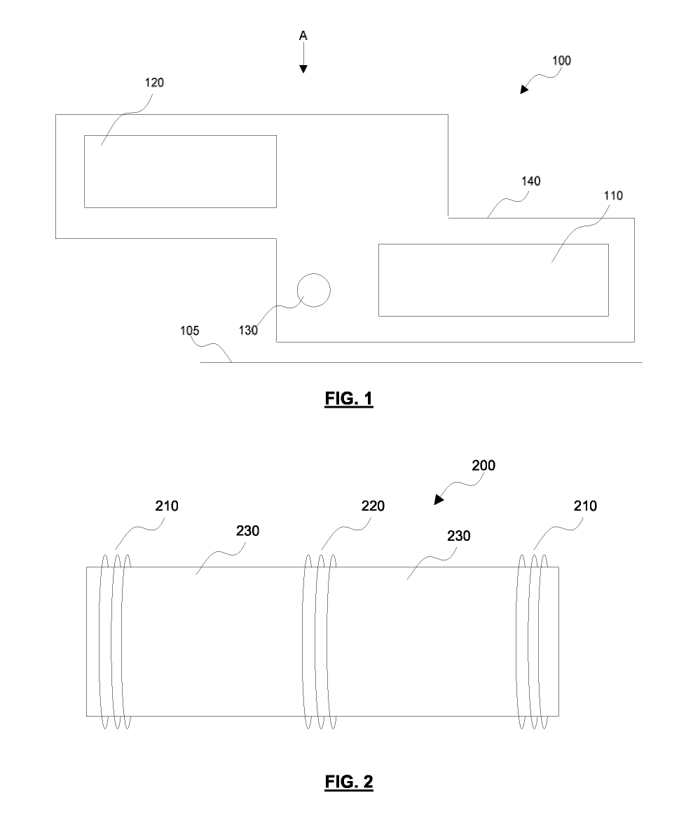

As shown in FIG. 2, in a conventional RF detector 200, such as is used in RFID technology, RFID receive 220 and transmit 210 coils are wound on a common core 230, with the receive coil 220 between conductively connected portions of the transmit coil 210. This arrangement places the receive coil 220 at a null point of the transmit coil 210. However, in order to obtain satisfactory performance for detecting buried assets, the present applicants determined that a transmit and receive antenna unit using this arrangement would need to be approximately 1 meter square or greater. This would be unwieldy in a handheld device. In contrast, similar performance is obtained by the arrangement of FIG. 1 with transmit 110 and receive 120 antennas each having an area approximately 30 cm². Accordingly, the arrangement of transmit 110 and receive 120 coils in the embodiment of FIG. 1 is more convenient than the conventional arrangement.

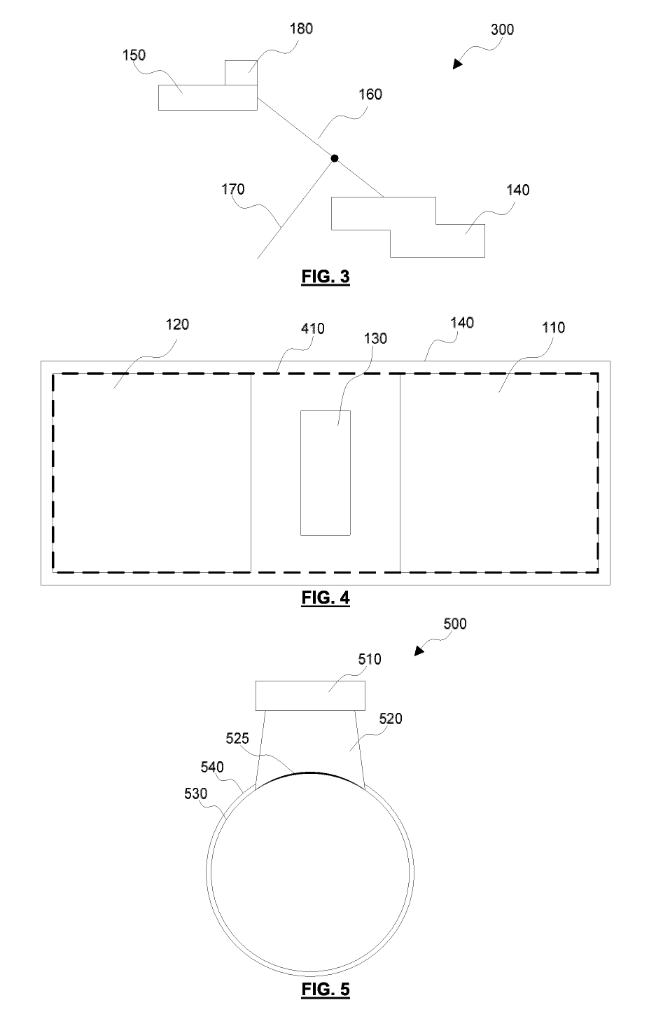

FIG. 3 shows an example of a device 300 incorporating the detector portion 100 of FIG. 1. The housing 140, containing the transmit 110 and receive 120 RF antennas is provided at a distal portion (bottom portion, or lower portion), of a shaft 160. A handle 150 is provided at a proximal portion (top portion, upper portion) of the shaft 160. A display and other electronics 180 may also be provided at the proximal portion of the shaft 160. A stand 170 may also be provided.

As can be seen in FIGS. 1 and 3, the CAT coil 130 may be provided in the detector portion 100, and outside the transmit antenna 110, without an increase, or without a significant increase, in the overall footprint of the device 300.

FIG. 4 is a view of the detector portion 100 along direction A, shown in FIG. 1. Preferably, when viewed perpendicular to the plane of the transmit antenna 110, the CAT coil 130 does not overlap the transmit 110 or receive 120 antennas, particularly the transmit antenna 110. Preferably, the CAT coil 130 is within the area 410 delimited, or bounded, by the transmit antenna 110 and receive antenna 120, such that the CAT coil 130 is within the footprint of the transmit antenna 110 and receive antenna 120.

An additional CAT coil may be provided. For example, the coil 130 may be a transmit coil, and a receive CAT coil may additionally be provided. In some cases, such as when beat-frequency oscillator technology is used in the CAT, the second CAT coil may be provided away from the RF transmit and receive coils, for example on shaft 160 sufficiently far from the RF transmit 110 and receive 120 antennas that a core of the second CAT coil does not result in interference with the RF antennas 110, 120.

FIGS. 1 and 2 show the transmit 110 and receive 120 antennas, and the CAT coil 130 in a single housing 140. However, they may be housed individually or in any combination.

Where separate housings are used for one or more of the components the housings may be connected by one or more support members. The shaft 160 may be a support member.

### Tag

According to another aspect of the invention, an RF tag is provided. The tag is arranged to resonate at a resonant frequency when excited by an incident RF signal at the resonant frequency and to reflect an RF signal at the same frequency.

The RF tag includes a coil electrically connected to circuitry so as to resonate at one or more frequencies. The circuitry may contain one or more capacitive elements, arranged with the coil to form an LC circuit. The coil and circuit may form a pi circuit. The circuit may contain an inductor, such that the coil and circuit have two resonant frequencies. Other components may be included in the circuit, and the circuit may have additional resonant frequencies.

According to the present aspect, the coil and circuitry are provided in a housing, such that the coil and circuitry are isolated from air, such that no air is in contact with the coil and circuitry. This extends the life of the coil and circuitry, as contact with air may lead to corrosion and premature failure. Similarly, the coil and circuitry may be isolate from water.

According to an embodiment, the housing includes a base having a coil wall. The base is preferably plastic. The tag is produced by winding conductive wire on the coil wall to produce the coil, such that the coil wall acts as a bobbin. The circuitry is electrically connected to the coil. The base may provide a section to receive or house the circuitry, and in this case the circuitry is located at this section. The coil and circuitry are then overmoulded with an air impermeable plastic. High pressure injection moulding may be used in the overmoulding process. The base and overmoulding plastic may be the same material.

In a preferred embodiment, the tag is for attachment to a buried asset, such as a plastic utility pipe. In this case, the tag may be made of the same material as the asset. This increases the likelihood that the tag will have a similar longevity to the asset that it is attached to.

Accordingly, a tag may be provided with a coil and circuitry that are hermetically sealed, such that air and moisture do not come into contact with the coil or circuitry.

### Tag for Ferrous Assets

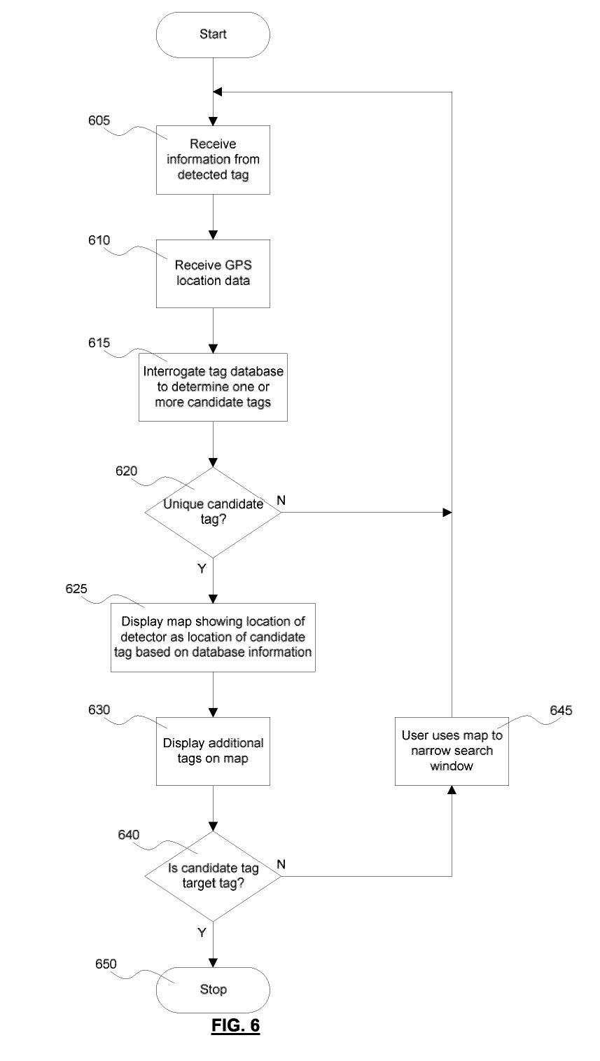

As noted above, the RF tagging technology is not suitable for use with metal assets. This is because flux lines from the transmit coil of the detector must pass through the coil of the tag and return to the transmit coil to excite the resonant frequency of the tag. When the tag is mounted on a ferrous asset, the flux lines, or the majority of flux lines, passing through the coil of the tag enter the asset rather than returning to the transmit coil. This results in insufficient excitation of the coil. A modified tag 500, adapted for use with metal assets is shown schematically in FIG. 5.

Section 510 of tag 500 includes similar components to known RF tags, such as a resonant circuit including a coil. Section 510 is attached to a mounting section 520. The mounting section having a seating portion 525 suitable for seating the tag 500 on the metal asset. FIG. 5 illustrates a metal pipe 530, seen along its axis, and seating portion 525 includes a concave surface that substantially conforms to the outer surface of the pipe. The tag 500 may be attached to the asset 530 by a strap 540, cable tie or similar means.

The mounting section 520 is arranged such that the tag 500, when in use, is separated from the asset by a sufficient distance that the tag 500 is detectable by an RF detector. In some embodiments, the distance between the tag 500 and the seating portion 525 (or, in use, the asset) is 10 cm or more. In some embodiments, this distance 15 cm or more. The distance is preferably chosen such that the disruption of the flux lines by the asset does not prevent the excitation of the tag coil, such that the reflected signal from the coil can be detected by the receive antenna of the detector.

Section 510 may be detachably attached to the mounting section 520. Section 510 and mounting section 520 may be provided separately and arranged be irreversibly connected, by a snap fitting, for example. Section 510 and mounting section 520 may be integrally formed.

An embodiment includes an RF coil; RF circuitry electrically connected to the coil; and

a housing, wherein the RF coil and RF circuitry are arranged to resonate at a predetermined frequency; the housing is arranged such that no air is in contact with the coil or circuitry. The RF coil and RF circuitry are preferably arranged to resonate at one or more predetermined frequencies.

### Location Determination

As described above, conventional civilian GPS is less accurate than is desired. Currently available solutions for improving the accuracy of GPS are expensive and impractical for many applications. Locating tags can be particularly challenging when surface landmarks change. For example, when a pavement has been widened such that an asset that was originally located beneath the road next to the pavement is now located beneath the pavement.

An aspect of the present invention provides a method of overcoming this shortcoming of civilian GPS. When a particular target tag is to be located, a user may interrogate a database of tags and locations to determine previously stored GPS coordinates of the target tag. The user may then use standard civilian GPS to transport the detector to the approximate location of the target tag. Preferably the detector is equipped with a GPS receiver, although a GPS receiver could alternatively be provided separate from, but close to the detector, to enable approximate GPS coordinates for the detector to be determined on the assumption that the GPS device is at the same location as the detector.

According to an embodiment of the method, illustrated in FIG. 6, the user may then begin a search for the tag using the detector. When a tag is detected, a processor receives information coded in the tag at step 605. This information may identify a type of tag, such as a tag for a particular type of utility (water, gas, etc) and/or a particular type of asset component (such as a pipe join, bend, T-junction, valve, etc.) This information may be coded in the form of one or more resonant frequencies of the tag, which have a predetermined meaning or which identify the tag as a particular type of tag. At step 610 the processor preferably obtains current

GPS coordinates of the detector, although recent GPS coordinates could also be used. The processor then interrogates the database at step 615 to determine one or more candidate tags. Candidate tags are tags in the region of the GPS coordinates that match the information received from the detected tag. So, for example, if a “water pipe/bend” tag is detected, all tags in the database carrying this information and having GPS coordinates within an expectation region around the current GPS coordinate of the device may be nominated as candidate tags. The expectation region is a region within which the detector is expected to be located, derived from the GPS coordinate of the detector and an expected error margin of the GPS. The region around the detector may be a circle having a 15 m radius, for example.

In some cases, the accuracy of the database tag location may be taken into account when determining candidate tags. So for example, each nearby tag may have an associated error margin associated with its location, defining a (normally circular) region in which the tag may actually be located. Matching tags (i.e. tags carrying the same information as the detected tag) having a region overlapping the expectation region around the detector may be nominated as candidate tags.

At step 620, it is determined whether a unique candidate tag has been identified, and if so, the processor may, at step 625, cause a map to be shown, indicating the location of the detector. The location of the detector, for displaying on the map, is assumed to be the location of the candidate tag in the database. The map may also include, at step 630, the locations of nearby tags. Where a particular target tag has been identified to the processor, the location of the target tag may also be indicated.

If, at step 640, it is determined that the detected tag is the target tag, the method stops at step 650. On the other hand, if the candidate tag is not the target tag, the user continues to search for tags, preferably using the information displayed on the map to narrow the search window or to guide the search. When a next tag is detected the method returns to step 605.

When more than one candidate tag is determined at step 615, the user continues searching for tags, and when a further tag is located, the method returns to step 605. When the method next reaches step 615, information on all located tags may be used. For example, assume a first tag is detected, and multiple candidate tags of a first type are identified. Subsequently a second tag of a second type is detected nearby, for which two candidate tags, tag A and tag B, of the second type are identified. In this case, if it is determined that tag A is close to a tag of the first type, and tag B is not, the current detector location can be determined to be at tag A, resulting in a single candidate tag for the second tag.

According to this embodiment, it is not necessary to determine the absolute location of the detector. Provided there is information on relative positions of the tags, the location of the detector relative to a target tag can be determined, to provide information to the user to permit the search area to be reduced. Thus, according to the present embodiment, the determination of location is a location relative to tags and/or assets, rather than an absolute location.

In some cases, the user will want to locate a plurality of tags in an area, and possibly all tags in an area. In this case, the target tag could be considered to be the next tag to be located. When a tag has been located, the user may determine the next tag to be located (i.e.

the new target tag) based on the map display, taking into account the determined location of the detector and the location of other tags illustrated on the map. When multiple tags have been detected in an area, the information on a plurality of the previously detected tags may be used when determining a candidate tag for a currently detected tag, e.g by eliminating matching tags that are inconsistent with previously detected tags.

Steps may be carried out in different orders in FIG. 6, as would be apparent to the skilled person. For example, steps 625 and 630 may be combined in a single step or may occur at the same time. Step 630 may occur before step 625. Indeed, prior to detecting a tag (in step 605) a map may be displayed showing tags in the region of the detector's GPS coordinates. The position of the detector based only on GPS coordinates may also be displayed. Furthermore, where there is a plurality of candidate tags, these may be indicated as possible locations for the detector.

In some embodiments, where a plurality of candidate tags are identified, a single candidate tag is selected, for example by taking the closest candidate tag to the location of the detector determined using GPS.

Some or all of steps 605, 610, 615, 620, 625, 630 and 640 may be performed by a processor. These steps may be performed local to the detector, for example in a portable terminal integral to or connected to the detector or in sort-range communication with the detector. Alternatively, the processor may be remote from the detector, for example a server in data communication with the detector, for example using mobile internet technology or mobile telephone technology. The database may be local to the detector, but is preferably remote from the detector. The detector may be in direct communication with the database. The detector may store a relevant subset of the database locally. The above steps may be performed by a number of processors at different locations. For example, some steps may be performed local to the detector while others may be performed at a location remote from the detector.

Information other than or additional to a map may be displayed or provided to the user to narrow the search window, such as a bearing and/or a distance.

In some embodiments the depth of the tag may be measured by the detector, for example based on signal strength and the type of soil. In this case, the depth information may also be used to identify or eliminate candidate tags.

The various aspects and embodiments of the invention may be used in conjunction with each other. For example, the detector described in relation to FIGS. 1 and 2 may be used with the tags described herein, and may perform some or all of the method described in relation to FIG. 6.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A detector comprising:
an RF tag detector including:
a radio-frequency, RF, transmit antenna, and
a RF receive antenna; and
a cable avoidance tool, CAT, antenna, wherein
the RF transmit antenna is substantially in a first plane, and
the RF receive antenna is positioned out of the first plane, such that the transmit and receive RF antennas do not overlap when viewed perpendicular to the first plane.

2. (canceled)

3. The detector of claim 1, wherein the RF receive and transmit antennas are arranged such that, in use, the first plane is substantially horizontal and the receive antenna is above the first plane.

4. The detector of claim 1, wherein the RF transmit antenna substantially defines a loop in the first plane, and the CAT antenna is outside the loop.

5. The detector of claim 1, wherein the CAT antenna is substantially in the first plane.

6. The detector of claim 1, wherein the CAT antenna is within an area bounded by the RF transmit and receive antennas when viewed perpendicular to the first plane.

7. The detector of claim 1, wherein the CAT antenna is between the RF transmit and receive antennas when viewed perpendicular to the first plane.

8. The detector of claim 1, wherein the CAT antenna has a ferrite core.

9. The detector of claim 1, wherein the ferrite core of the CAT antenna is a ferrite rod elongate along an axis, and the axis of the CAT antenna is essentially parallel to the first plane.

10-13. (canceled)

14. An underground utility RF tag comprising:
an RF coil;
RF circuitry electrically connected to the coil;
a housing portion; and
a mounting section attachable to the housing, the mounting section having a seating portion suitable for seating on a metal asset, wherein
the mounting section is arranged such that the seating portion is spatially separated from the housing when the mounting section is attached to the housing, and the spatial separation is 10 cm or more.

15. The underground utility RF tag of claim 14, wherein the spatial separation is such that the ID tag is detectable by an RF detector when the seating portion is seated on the metal utility pipe.

16. (canceled)

17. The underground utility RF tag of claim 14, wherein the spatial separation is 15 cm or more.

18. An underground utility detection system comprising:
the underground utility RF tag of claim 15;
and the RF detector.

19. A method of determining a location of an RF detector comprising:
receiving GPS information identifying an approximate location of the RF detector;
receiving information from the RF detector representing a signal from an underground RF tag, the signal identifying a type of the tag;
determining the location based on the approximate location and previously recorded information on tag locations.

20. The method of claim 19 further comprising displaying the location on a map.

21. The method of claim 19, wherein the method is performed by:
a processor within the detector, or
a server remote from the detector, or
the detector and server in combination.

22. An apparatus or system arranged to perform the method of claim 19.

23. A computer program arranged to cause a computer to perform the method of claim 19.
